(19) United States
(12) Patent Application Publication
(10) Pub. No.: US 2012/0099865 A1
(43) Pub. Date: Apr. 26, 2012

(54) OPTICAL ACCESS SYSTEM, STATION-SIDE TERMINATION APPARATUS, AND SUBSCRIBER-SIDE TERMINATION APPARATUS

(75) Inventors: Kenji Ishii, Tokyo (JP); Junichi Nakagawa, Tokyo (JP)

(73) Assignee: MITSUBISHI ELECTRIC CORPORATION, Tokyo (JP)

(21) Appl. No.: 13/379,369

(22) PCT Filed: Jun. 23, 2009
(86) PCT No.: PCT/JP2009/061413

§ 371 Date: Dec. 20, 2011

(51) Int. Cl. H04J 14/00; H04B 10/18; H04L 27/01

(52) U.S. Cl. 398/66; 398/136

(57) ABSTRACT

In an optical access system, the OLT includes a CP inserting unit that inserts a CP into a downlink signal; a CP removing unit that removes a CP from an uplink signal received from the ONU; and an FFT unit, an EQ unit, and an inverse FFT unit that perform equalization on the uplink CP-removed signal according to a frequency domain equalization scheme based on an inverse characteristic of the characteristic of a transmission line leading to the ONU. The ONU includes a CP inserting unit; a CP removing unit; and an FFT unit, an EQ unit, and an inverse FFT unit that perform equalization on the downlink CP-removed signal according to the frequency domain equalization scheme based on an inverse characteristic of the prestored characteristic of the a transmission line leading to the OLT.

### FIELD

The present invention relates to an optical access system, a station-side termination apparatus, and a subscriber-side termination apparatus, which can perform communication using optical fibers.

### BACKGROUND

Along with the spread of the Internet in these years, speeding-up is required for access networks, but because of the increase in the transmission speed of light signals, the problem occurs that the signals after transmission are degraded due to dispersion in optical fibers (such as a wavelength dispersion). As to a method to solve the problem, the use of dispersion-compensating fibers or dispersion-shifting fibers, and a technique in which a circuit for a time-domain electric dispersion compensation is applied to a termination apparatus as described in, e.g., Patent Literature 1 are being studied.

### CITATION LIST

### Patent Literature

Patent Literature 1: Japanese Patent Application Laid-open No. 2008-312072

### SUMMARY

### Technical Problem

However, with the conventional technique where dispersion-compensating fibers or dispersion-shifting fibers are used, there is the problem that the cost of optical fibers themselves and the installation cost increase. Further, because fibers must be arranged such that dispersion is zero for all subscriber-side termination apparatuses, there is a problem that the design of the network is made complicated.

As to the conventional technique where an electric dispersion compensation circuit is applied to a termination apparatus, for example, FFE (Feed Forward Equalization) and DFE (Decision Feedback Equalization) are well known as electric dispersion compensation in time domain, where the amount of dispersion to be compensated for can be changed by changing tap coefficients. Hence, processing capability to deal with a change in the number of taps and an increase in the number of taps due to the difference in path is needed, and thus there is the problem that the circuit scale increases and the memory increases, resulting in an increase in cost.

The present invention has been provided in view of the above facts, and an object thereof is to provide an optical access system, a station-side termination apparatus, and a subscriber-side termination apparatus which can compensate for dispersion in optical fibers and also suppress the cost.

### Solution to Problem

In order to solve the aforementioned problems, an optical access system including a station-side termination apparatus and a subscriber-side termination apparatus according to one aspect of the present invention is constructed in such a manner that the station-side termination apparatus includes: a station-side CP inserting unit that inserts a cyclic prefix into a downlink signal to be transmitted to the subscriber-side termination apparatus and transmits the cyclic prefix-inserted signal to the subscriber-side termination apparatus; a station-side CP removing unit that generates an uplink CP-removed signal by removing a cyclic prefix from an uplink signal received from the subscriber-side termination apparatus; and a station-side equalization unit that performs equalization on the uplink CP-removed signal according to a frequency domain equalization scheme based on an inverse characteristic of the prestored characteristics of a transmission line leading to the subscriber-side termination apparatus, and the subscriber-side termination apparatus includes: a subscriber-side CP inserting unit that inserts a cyclic prefix into an uplink signal to be transmitted to the station-side termination apparatus and transmits the cyclic prefix-inserted signal to the station-side termination apparatus; a subscriber-side CP removing unit that generates a downlink CP-removed signal by removing a cyclic prefix from a downlink signal received from the station-side termination apparatus; and a subscriber-side equalization unit that performs equalization on the downlink CP-removed signal according to the frequency domain equalization scheme based on an inverse characteristic of the prestored characteristic of a transmission line leading to the station-side termination apparatus.

### Advantageous Effects of Invention

With the equalization circuit according to the present invention, in communication between an OLT and ONUs, the transmission side performs CP insertion, and the reception side performs equalization according to an SC-FDE scheme, and hence the effect is produced that dispersion in optical fibers can be compensated for, yet with suppressing the cost.

### BRIEF DESCRIPTION OF DRAWINGS

FIG. 1 is a diagram showing an example configuration of the optical access system of first embodiment.

FIG. 2 is a diagram showing an example of the flow of the equalization process according to an SC-FDE scheme of first embodiment.

FIG. 3 is a diagram showing Er(n).

FIG. 4 is a diagram showing an example of the configuration of the optical access system of second embodiment.

FIG. 5 is a diagram showing an example of the flow of the equalization process according to the SC-FDE scheme of second embodiment.

### DESCRIPTION OF EMBODIMENTS

Embodiments of an optical access system, a station-side termination apparatus, and a subscriber-side termination apparatus according to the present invention will be described in detail below with reference to the drawings. Note that these embodiments are not intended to limit the present invention.

### First Embodiment

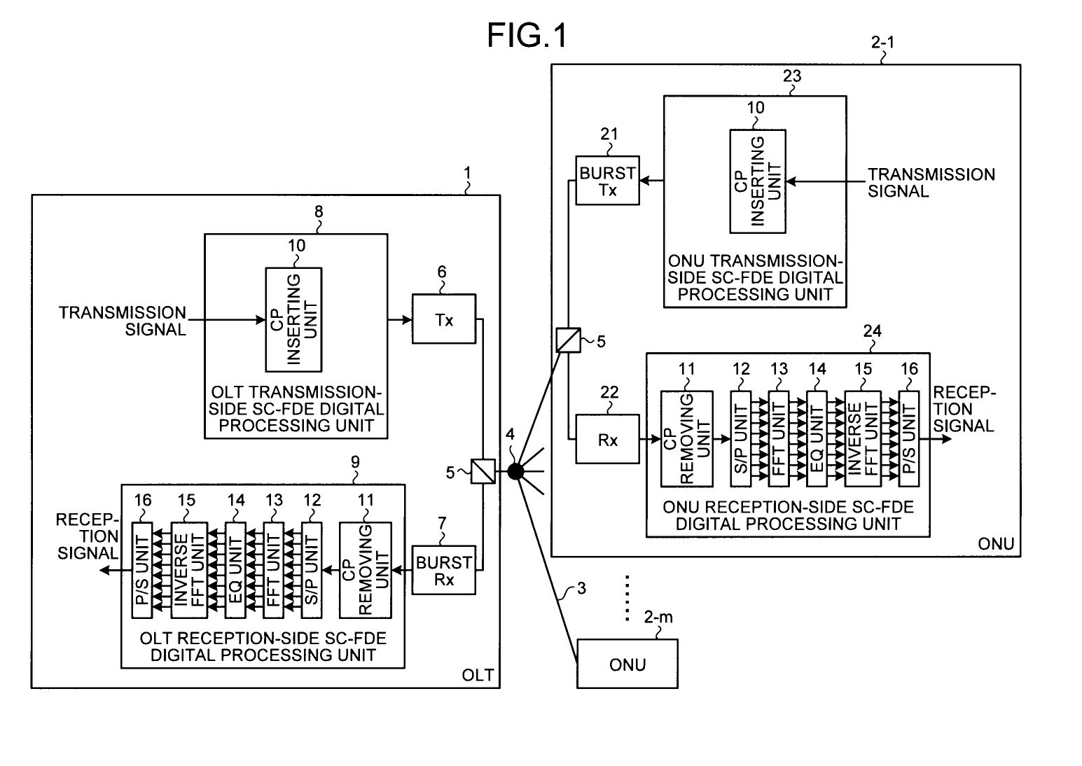

FIG. 1 is a diagram showing an example of the configuration of first embodiment of the optical access system according to the present invention. As shown in FIG. 1, the optical access system of the present embodiment is a PON (Passive Optical Network) system including a station-side termination apparatus (OLT: Optical Line Terminal) 1, subscriber-home termination apparatuses (ONUs: Optical Network Units) 2-1, 2-2, and an optical multiplexing/demultiplexing device 4. The OLT 1 is connected to ONUs 2-1 to 2-m, where m is an integer equal to or greater than 2, via optical fibers 3 and the optical multiplexing/demultiplexing device 4. The optical access system of the present embodiment can be applied to, for example, ultra high-speed communications and long-distance communications of 100 Gbps transmission speed and about 20 km transmission distance, which are made to be of high dispersion-tolerance, a large capacity, and of a long distance.

The OLT 1 includes a WDM (Wavelength Division Multiplexing) filter 5 that multiplexes/demultiplexes light signals transmitted and received, an optical transmitter (Tx) 6, a burst optical receiver (burst Rx) 7, an OLT transmission-side SC-FDE (Single-Carrier modulation with Frequency Domain Equalization) digital processing unit 8, and an OLT reception-side SC-FDE digital processing unit 9.

The ONU 2-1 includes a WDM filter 5, a burst optical transmitter (burst Tx) 21, an optical receiver (Rx) 22, an ONU transmission-side SC-FDE digital processing unit 23, and an ONU reception-side SC-FDE digital processing unit 24. The ONUs 2-2 to 2-m have the same configuration as the ONU 2-1.

In this embodiment, equalization according to an SC-FDE scheme is performed. The SC-FDE scheme is a scheme, in which a simple carrier wave is used, characterized by an equalization in frequency domain, but not in time domain which has been a method generally used so far. In an OFDM (Orthogonal Frequency Division Multiplexing) scheme which also uses frequency-domain equalization, a plurality of carrier waves are used, so that a ratio of peak power to average power (PAPR: Peak to Average Power Ratio) is made large, resulting in an enlarged power consumption of the amplifier. In contrast, in the SC-FDE scheme, a single frequency is used, so that the bandwidth can be extended, yet suppressing an increase in the power consumption.

Specifically, in the SC-FDE scheme, a transmission unit performs a digital process of copying a plurality of data symbols at the frame end called a Cyclic Prefix and adding them to the beginning of the block. And, a reception unit performs a digital process of performing a discrete Fourier transform on a received signal block with the cyclic prefix removed to decompose into orthogonal frequencies, and multiplying the signals of the decomposed frequency components by the inverse characteristic of the channel for equalization, and performing a discrete Fourier inverse transform, thereby obtaining the original signal in the time domain.

Next, the configurations of the digital processing units of this embodiment will be described. The OLT transmission-side SC-FDE digital processing unit 8 of the OLT 1 and the ONU transmission-side SC-FDE digital processing unit 23 of the ONU 2-1 are the same in configuration since they perform SC-FDE processings on the transmission side. The OLT reception-side SC-FDE digital processing unit 9 and the ONU reception-side SC-FDE digital processing unit 24 are the same in configuration since they perform SC-FDE processings on the reception side.

The OLT transmission-side SC-FDE digital processing unit 8 of the OLT 1 and the ONU transmission-side SC-FDE digital processing unit 23 of the ONU 2-1 include a CP inserting unit 10 that is a circuit for adding a cyclic prefix (CP) to a signal (CP insertion).

The OLT reception-side SC-FDE digital processing unit 9 and the ONU reception-side SC-FDE digital processing unit 24 of the ONU 2-i, where i=1, 2, . . . , m, include a CP removing unit 11 that is a circuit for removing the cyclic prefix added to a received signal (CP removal); an S/P (Serial/Parallel) unit 12 that is a circuit for converting the CP-removed signal from serial to parallel; and an FFT (Fast Fourier Transform) unit 13 that is a circuit for orthogonal-frequency decomposing the parallel signal by discrete Fourier transform. The OLT reception-side SC-FDE digital processing unit 9 and the ONU reception-side SC-FDE digital processing unit 24 of the ONU 2-i further include an EQ unit 14 that is an equalizer for equalizing the decomposed frequency components using the inverse characteristic of the transmission line for the received signal (the transmission line from the ONU 2-i to the OLT 1 or from the OLT 1 to the ONU 2-i); an inverse FFT unit 15 that is a circuit for transforming the equalized signal into a time domain signal by discrete Fourier inverse transform; and a P/S (Parallel/ Serial) unit 16 that is a circuit for converting a parallel signal into a serial signal.

Next, the operation of this embodiment will be described. First, communication from the OLT 1 to the ONU 2-i will be described. In the OLT 1, first, a transmission signal is input to the OLT transmission-side SC-FDE digital processing unit 8. The CP inserting unit 10 in the OLT transmission-side SC-FDE digital processing unit 8 inserts a CP into the transmission signal. The insertion of a CP means copying the end of a signal block and inserting it into the beginning of the signal. By this CP insertion, even if a delayed wave exists at the time of its reception, the periodicity of the received signal is secured up to the length of the CP, and also ISI (Inter-Symbol Interference) can be prevented.

The OLT transmission-side SC-FDE digital processing unit 8 outputs the CP-inserted transmission signal to the optical transmitter 6. The optical transmitter 6 converts the input transmit signal from an electric signal to a light signal, outputs to the WDM filter 5, and transmits to the ONUs 2-1 to 2-n via the WDM filter 5. Then, the coupler 4 demultiplexes the light signal output from the WDM filter 5, and the demultiplexed signals are input to the ONUs 2-1 to 2-m via the optical fibers 3.

In the ONU-i, the optical receiver 22 converts the light signal received from the OLT 1 via the optical fiber 3 and the WDM filter 5 into an electric signal. In the ONU reception-side SC-FDE digital processing unit 24, first, the CP removing unit 11 removes the CP inserted on the transmission side from the converted electric signal, and the S/P unit 12 converts the CP-removed serial signal into a parallel signal. The FFT unit 3 decomposes the parallel signal into orthogonal frequency components, and the EQ unit 14 equalizes the decomposed signal frequency components using the inverse characteristic of the transmission line between the OLT 1 and the ONU 2-i.

Note that in a fixed network of the PON system, once the system has been installed, the transmission lines from the OLT 1 to the ONUs 2-1 to 2-m are each determined uniquely, with there being no change in the transmission line characteristic. Thus, the ONUs 2-1 to 2-m hold beforehand information about the path at their received wavelength from the OLT 1 which accommodates them to themselves, and thereby can always perform the same equalization on the received signal from the OLT 1.

Then, the inverse FFT unit 15 transforms the equalized signal into a time domain signal, and the P/S unit 16 converts the parallel signal transformed to time domain into a serial signal, so that the original signal transmitted from the OLT 1 can be extracted.

Next, communications from the ONU 2-i to the OLT 1 will be described. First, a transmission signal is input to the ONU transmission-side SC-FDE digital processing unit 23. The CP inserting unit 10 in the ONU transmission-side SC-FDE digital processing unit 23 inserts a CP into the transmission signal and outputs the CP-inserted transmission signal to the optical transmitter 6. The burst optical transmitter 6 converts the input transmission signal from an electric signal to a burst light signal, outputs to the WDM filter 5, and transmits to the OLT 1 via the WDM filter 5. Then, the OLT 1 receives the burst light signal output from the WDM filter 5 via the optical fiber 3 and the coupler 4.

The burst optical receiver 7 of the OLT 1 converts the signal received from the ONU 2-i via the WDM filter 5 from a light signal into an electric signal. The OLT reception-side SC-FDE digital processing unit 9 of the OLT 1 performs the same process as does the ONU reception-side SC-FDE digital processing unit 24 of the ONU 2-i, but the EQ unit 14 performs equalization using the inverse characteristic of the transmission line between the ONU 2-i and the OLT 1. As described previously, the PON system is a fixed network where once the system has been installed, the transmission lines are determined uniquely. Hence, the OLT 1 holds beforehand the characteristics of the transmission lines from itself to all the ONUs 2-1 to 2-m that the OLT 1 accommodates, and multiplies the received signal by an appropriate transmission line inverse characteristic based on the transmission line characteristic corresponding to the ONU that is the originator thereof, and the signal can thus be equalized.

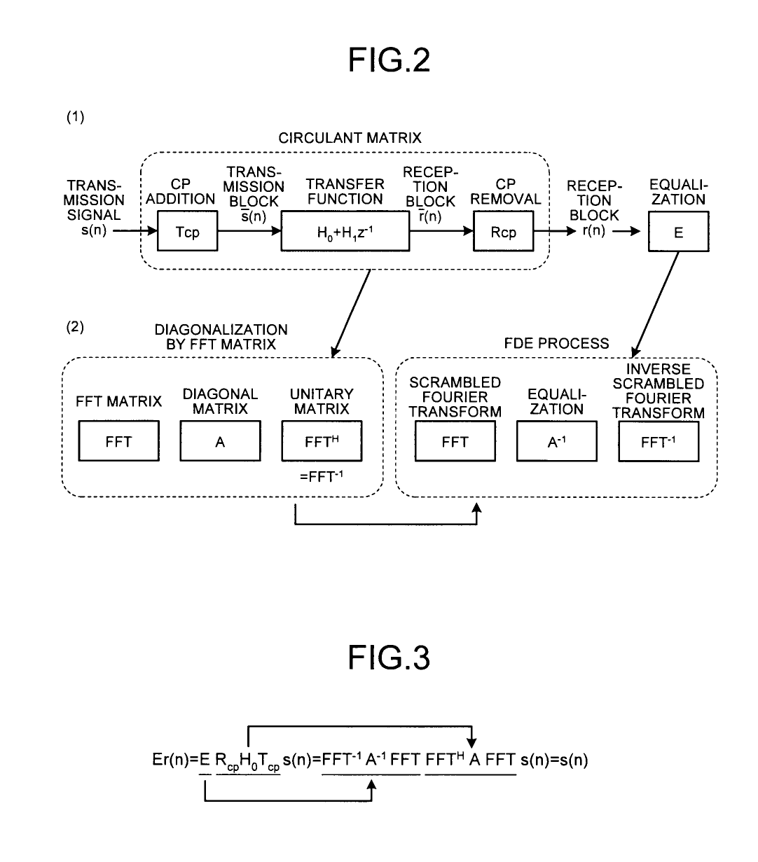

Next, an example of a method of realizing the equalization process of this embodiment will be described. FIG. 2 is a diagram showing an example of the flow of the equalization process according to the SC-FDE scheme of this embodiment. Let a transmit signal s(n) be the nth block signal in a block transmission scheme, then the transmit signal s(n) can be expressed by a matrix having M number of elements as denoted by the following equation (1).

$$s [ n ] = [ \begin{matrix}{s}_{0} [ n ] \\ ⋮ \\ {s}_{M - 1} ( n )\end{matrix} ] \qquad ( 1 )$$

By performing a process Tcp of adding K number of cyclic prefixes to this signal (multiplying by a matrix Tcp), [s_{M-K}(n) to s_{M-1}(n)] from among the elements of s(n) are added to the beginning of the signal to generate a transmit block s(with a superscript bar)(n) having Q(=M+K) number of elements as shown by the following equation (2).

$$\begin{matrix}\overline{s} [ n ] = {T}_{cp *} s ( n ) \\ = [ \begin{matrix}{0}_{K \times ( M - K )} {I}_{K} \\ {I}_{M}\end{matrix} ] [ \begin{matrix}{s}_{0} ( n ) \\ ⋮ \\ {s}_{M - 1} ( n )\end{matrix} ] \\ = [ \begin{matrix}{s}_{M - K} ( n ) \\ ⋮ \\ {s}_{M - 1} ( n ) \\ {s}_{0} ( n ) \\ ⋮ \\ {s}_{M - 1} ( n )\end{matrix} ] \\ = [ \begin{matrix}{s}_{0} ( n ) \\ ⋮ \\ \overline{{s}_{Q - 1}} ( n )\end{matrix} ]\end{matrix} \\ ( Q = M + K ) \qquad ( 2 )$$

Let r(with a superscript bar) (n) denote a receiving block after passing through a transmission line, its elements being [r(with a superscript bar)₀ to r(with a superscript bar)_{Q}]. Here assuming, for the transmission line characteristic, that any reception symbol rₓ is subject to the influence of transmission symbols sₓ preceding by up to L(≦K) number, a reception symbol r(with a superscript bar)ₓ can be expressed by the following equation (3).

$$\overline{{r}_{x}} = {\sum }_{i = 0}^{L} {h}_{i} \overline{{s}_{x - i}} \qquad ( 3 )$$

Thus, a reception block r(with a superscript bar)(n), subject to inter-block interference from the (n−1)'th block signal and influence of signals within the same block, can be expressed by the following equation (4).

$$\begin{matrix}\overline{r ( n )} = [ \begin{matrix}0 & … & {h}_{L} & … & {h}_{0 } & 0 & … & 0 \\ ⋮ & & & ⋱ & & ⋱ & & ⋮ \\ ⋮ & & & & ⋱ & & ⋱ & 0 \\ 0 & … & … & … & 0 & {h}_{L} & … & {h}_{0}\end{matrix} ] [ \begin{matrix}\overline{{s}_{0}} ( n - 1 ) \\ ⋮ \\ \overline{{s}_{Q - 1}} ( n - 1 ) \\ \overline{{s}_{0}} ( n ) \\ ⋮ \\ \overline{{s}_{Q - 1}} ( n )\end{matrix} ] \\ = {H}_{1} \overline{s} ( n - 1 ) + {H}_{0} \overline{s} ( n )\end{matrix} \qquad ( 4 )$$

By performing a process R_{cp} for removing the CP on r(with a superscript bar)(n) (multiplying by a matrix R_{cp}) as shown in the following equation (5), a received signal r(n) having M number of elements can be obtained.

$$\begin{matrix}r ( n ) = {R}_{cp} \overline{r ( n )} \\ = [ {0}_{( Q - K ) \times K} {I}_{Q - K} ] \overline{r ( n )} \\ = {R}_{cp} {H}_{1} \overline{s} ( n - 1 ) + {R}_{cp} {H}_{0} {T}_{cp} s ( n ) \\ = [ \begin{matrix}{h}_{0} & 0 & … & 0 & {h}_{L} & … & {h}_{1} \\ ⋮ & {h}_{0} & ⋱ & & ⋱ & ⋱ & ⋮ \\ ⋮ & & ⋱ & ⋱ & & ⋱ & {h}_{L} \\ {h}_{L} & & & ⋱ & ⋱ & & 0 \\ 0 & ⋱ & & & ⋱ & ⋱ & ⋮ \\ ⋮ & ⋱ & ⋱ & & & ⋱ & 0 \\ 0 & … & 0 & {h}_{L} & … & … & {h}_{0}\end{matrix} ] s ( n )\end{matrix} \qquad ( 5 )$$

As such, by performing the process R_{cp}, the influence of the (n−1)'th and preceding block signals can be removed. As such, the process R_{cp} having been performed thereon, an FDE equalization process E (multiplication by a matrix E) is performed on the r(n) as shown in the following equation (6), so that an FDE equalization result Er(n) is obtained.

Er(n)=E R_{cp} H₀ T_{cp} s(n)=s(n) (6)

As shown in FIG. 2, the matrix representation of from the CP insertion to the CP removal can be expressed by a circulant matrix. The circulant matrix has several characteristics, and the characteristic that the circulant matrix is diagonalized by discrete Fourier transform is used. By using this characteristic, the processes from the CP insertion to the CP removal can be expressed by the product of a matrix FFT denoting an FFT operation, a diagonal matrix A, and the unitary matrix FFT^{H} (=FFT⁻¹) of the matrix FFT as shown on the left side in (2) of FIG. 2.

Further, using the fact that the inverse matrix of the circulant matrix of an inverse matrix is a circulant matrix, if the FDE process (equalization process E) of this embodiment is set to be the inverse matrix of the processes from the CP insertion to the CP removal, then the FDE process can be expressed by the product of the matrix FFT, the inverse matrix A⁻¹ of the diagonal matrix A, and the inverse matrix FFT⁻¹ of the FFT.

FIG. 3 is a diagram showing the Er(n). FIG. 3 shows the modulated form of the above equation (6) using the above circulant matrixes. Thus, all the processes from the CP insertion to the equalization, which are performed on the transmit signal s(n), cancel out, so that the original signal s(n) can be obtained. The EQ unit 14 performing the equalization can reproduce a transmitted signal if the matrix A⁻¹ shown in (2) of FIG. 2 is known as information about the transmission path.

In this embodiment, since the equalization process (FDE process) according to the SC-FDE scheme is executed by the FFT unit 13, the EQ unit 14, and the inverse FFT unit 15 as described above, the FFT unit 13, the EQ unit 14, and the inverse FFT unit 15 can be regarded as being an SC-FDE equalization means.

Because the communication lines are determined uniquely, the PON system has the advantage that, in a case where the SC-FDE scheme is applied thereto, after the equalization process is performed once, only the same process has to be repeated. Further, the number of necessary memories can be suppressed as compared with the case of performing equalization in time domain.

As such, in the present embodiment, in communications between the OLT 1 and the ONUs 2-1 to 2-m, the transmission side performs the CP insertion, and the reception side performs the equalization according to the SC-FDE scheme. Hence, the process can be simplified and the number of necessary memories can be suppressed as compared with the case in which dispersion of optical fibers is compensated for equalization in time domain is performed, thereby suppressing the cost.

### Second Embodiment

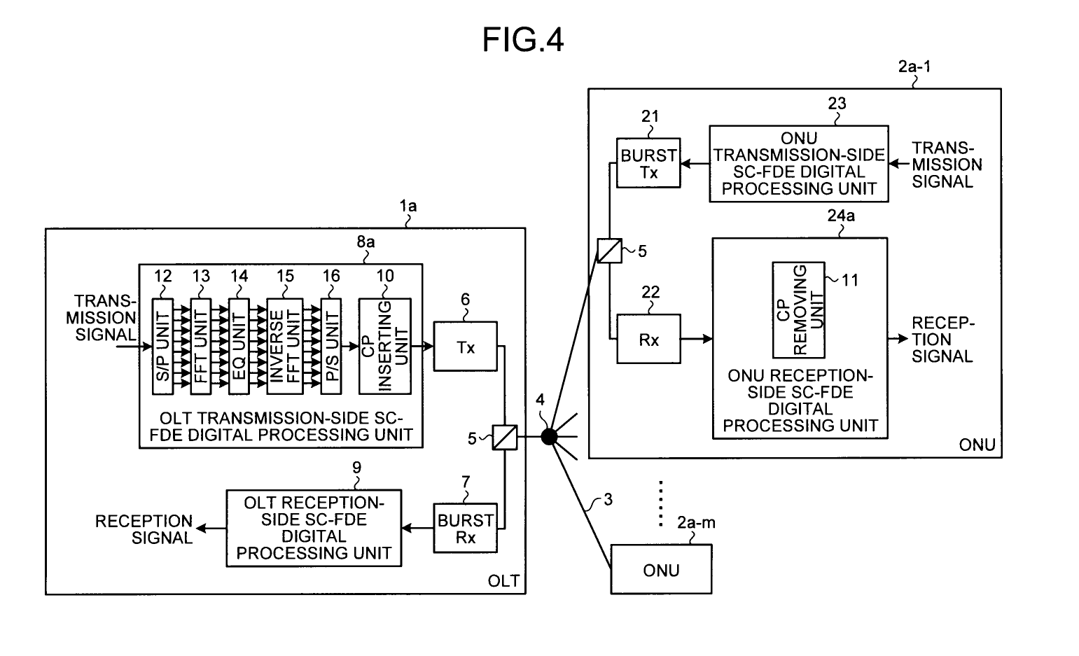

FIG. 4 is a diagram showing an example of the configuration of second embodiment of the optical access system according to the present invention. As shown in FIG. 4, the optical access system of the present embodiment is the same as the optical access system of first embodiment except that the OLT 1 of the optical access system of first embodiment is replaced by an OLT 1a and that the ONUs 2-1 to 2-m are replaced by ONUs 2a-1 to 2a-m. The same reference numerals are used to denote constituents having the same or similar functions as in first embodiment, with the description thereof being omitted.

The OLT 1a is the same as the OLT 1 of first embodiment except that the OLT transmission-side SC-FDE digital processing unit 8 of the OLT 1 of first embodiment is replaced by an OLT transmission-side SC-FDE digital processing unit 8a. The ONU 2-i, where i=1, 2, . . . , m, is the same as the ONU 2-i of first embodiment except that the ONU reception-side SC-FDE digital processing unit 24 of the ONU 2-i of first embodiment is replaced by an ONU reception-side SC-FDE digital processing unit 24a.

The OLT transmission-side SC-FDE digital processing unit 8a includes the S/P unit 12, the FFT unit 13, the EQ unit 14, the inverse FFT unit 15, and the P/S unit 16 just as the OLT reception-side SC-FDE digital processing unit 9 and the ONU reception-side SC-FDE digital processing unit 24 of first embodiment, and further includes the CP inserting unit 10 just as the OLT transmission-side SC-FDE digital processing unit 8 and the ONU transmission-side SC-FDE digital processing unit 23 of first embodiment. The ONU reception-side SC-FDE digital processing unit 24a includes the CP removing unit 11 just as the ONU reception-side SC-FDE digital processing unit 24 of first embodiment.

In the present embodiment, the OLT reception-side SC-FDE digital processing unit 9 and the ONU transmission-side SC-FDE digital processing unit 23 are the same as in first embodiment. That is, the operation for communications in the direction of the transmission from the ONU 2a-i to the OLT 1a is the same as the operation for the transmission from the ONU 2-i to the OLT 1 in first embodiment. Meanwhile, in communications in the direction of the transmission from the OLT la to the ONUs 2a-1 to 2a-m, the process that is performed by the S/P unit 12 through the P/S unit 16 on the reception side in first embodiment is performed on the transmission side differently from first embodiment, and on the reception side only the CP removal is performed.

Because the operation of communications in the direction of the transmission from the ONU 2a-i to the OLT 1a is the same as in first embodiment, the description thereof is omitted. In communication from the OLT 1a to the ONU 2a-i, first a transmission signal is input to the OLT transmission-side SC-FDE digital processing unit 8a. In the OLT transmission-side SC-FDE digital processing unit 8a, the S/P unit 12 converts the input transmit signal into a parallel signal, and the FFT unit 13 decomposes the parallel signal into orthogonal frequency components. Then the EQ unit 14 pre-equalizes the decomposed transmission signal frequency components using the inverse characteristic of the transmission line from the OLT 1 to the ONU 2-i.

Then, the inverse FFT unit 15 transforms the signal pre-equalized by the EQ unit 14 into a time domain signal, and the P/S unit 16 converts the parallel signal into a serial signal. The CP inserting unit 11 inserts a CP into the serial signal and outputs to the optical transmitter 6. The process from the action by the optical transmitter 6 to the reception by the ONU 2a-i of the signal transmitted by the OLT la is the same as in first embodiment. In the ONU 2a-i, the ONU reception-side SC-FDE digital processing unit 24a removes the CP from the received signal.

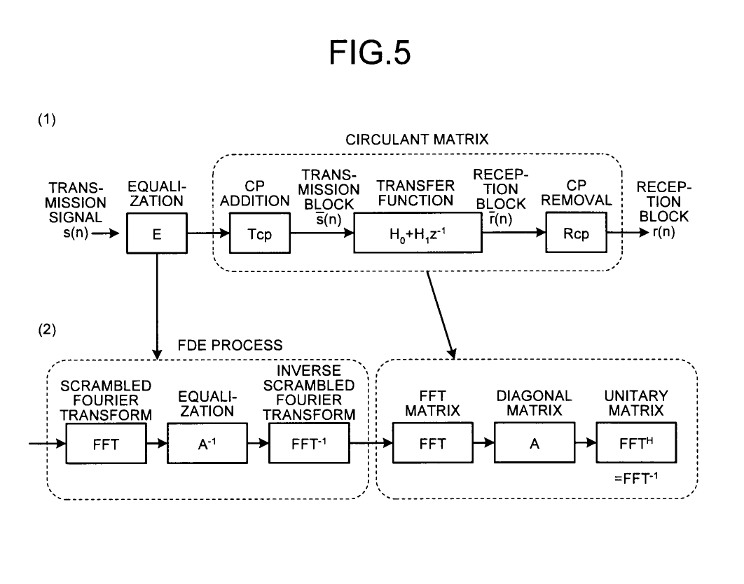

Next, an exemplary method of realizing the equalization process of this embodiment will be described. FIG. 5 is a diagram showing an example of the flow of the equalization process according to the SC-FDE scheme of this embodiment. As shown in (1) of FIG. 5, in this embodiment, the equalization process E is performed before the CP addition. Then, after the CP addition, the signal passes through the transmission path, and the CP removal in the R_{cp} is performed. The processes from the CP addition to the CP removal is expressed by a circulant matrix as in first embodiment. Thus, by using the characteristic that the circulant matrix is diagonalized by a discrete Fourier transform matrix, the processes from the CP addition to the CP removal can be expressed by the product of a matrix FFT, a diagonal matrix A, and the unitary matrix FFT^{H} of the matrix FFT as in first embodiment.

Further, using the fact that the inverse function of a circulant matrix is a circulant matrix, the FDE equalization process (equalization process E) can be set to be the inverse matrix of the processes from the CP addition to the CP removal. Thus, by applying this inverse matrix process to the transmission signal beforehand, the original signal can be extracted from the received signal as shown in (3) of FIG. 5.

As such, in the present embodiment, regarding the communications between the OLT 1 and the ONUs 2a-1 to 2a-m, in communications from the OLT 1 to the ONUs 2a-1 to 2a-m, the OLT 1, after performing the pre-equalization according to the SC-FDE scheme, performs the CP insertion, and the reception side performs the CP removal. Hence, the same effect as in first embodiment can be obtained, and in addition circuits for equalization according to the SC-FDE scheme need not be mounted on the ONUs 2a-1 to 2a-m side, and thus for the ONUs 2a-1 to 2a-m, the number of parts can be reduced and the power consumption can also be reduced.

### INDUSTRIAL APPLICABILITY

As described above, the optical access system, the station-side termination apparatus, and the subscriber-side termination apparatus according to the present invention are useful for the PON system and suitable especially for the PON system which compensates for dispersion caused by optical fibers.

### REFERENCE SIGNS LIST

1 OLT

2-1 to 2-m, 2a-1 to 2a-m ONU

3 OPTICAL FIBER

4 OPTICAL MULTIPLEXING/DEMULPTIPLEXING DEVICE

5 WDM FILTER

6 Tx

7 BURST Rx

8, 8a OLT TRANSMISSION-SIDE SC-FDE DIGITAL PROCESSING UNIT

9 OLT RECEPTION-SIDE SC-FDE DIGITAL PROCESSING UNIT

10 CP INSERTING UNIT

11 CP REMOVING UNIT

12 S/P UNIT

13 FFT UNIT

14 EQ UNIT

15 INVERSE FFT UNIT

16 P/S UNIT

21 BURST Tx

22 Rx

23 ONU TRANSMISSION-SIDE SC-FDE DIGITAL PROCESSING UNIT

24, 24a ONU RECEPTION-SIDE SC-FDE DIGITAL PROCESSING UNIT

1. An optical access system including a station-side termination apparatus and a subscriber-side termination apparatus,
wherein the station-side termination apparatus comprises:
a station-side CP inserting unit that inserts a cyclic prefix into a downlink signal to be transmitted to the subscriber-side termination apparatus and transmits the cyclic prefix-inserted signal to the subscriber-side termination apparatus;
a station-side CP removing unit that generates an uplink CP-removed signal by removing a cyclic prefix from an uplink signal received from the subscriber-side termination apparatus; and
a station-side equalization unit that performs equalization on the uplink CP-removed signal according to a frequency domain equalization scheme based on an inverse characteristic of the prestored characteristics of a transmission line leading to the subscriber-side termination apparatus, and
wherein the subscriber-side termination apparatus comprises:
a subscriber-side CP inserting unit that inserts a cyclic prefix into an uplink signal to be transmitted to the station-side termination apparatus and transmits the cyclic prefix-inserted signal to the station-side termination apparatus;
a subscriber-side CP removing unit that generates a downlink CP-removed signal by removing a cyclic prefix from a downlink signal received from the station-side termination apparatus; and
a subscriber-side equalization unit that performs equalization on the downlink CP-removed signal according to the frequency domain equalization scheme based on an inverse characteristic of the prestored characteristic of a transmission line leading to the station-side termination apparatus.

2. An optical access system including a station-side termination apparatus and a subscriber-side termination apparatus,
wherein the station-side termination apparatus comprises:
a station-side pre-equalization unit that performs pre-equalization on a downlink signal to be transmitted to the subscriber-side termination apparatus according to a frequency domain equalization scheme based on inverse characteristic of the prestored characteristic of a transmission line leading to the subscriber-side termination apparatus;
a station-side CP inserting unit that generates an uplink CP-inserted signal by inserting a cyclic prefix into the pre-equalized signal and transmits the CP-inserted signal to the subscriber-side termination apparatus;
a station-side CP removing unit that generates an uplink CP-removed signal by removing a cyclic prefix from an uplink signal received from the subscriber-side termination apparatus; and
a station-side equalization unit that performs equalization on the uplink CP-removed signal according to the frequency domain equalization scheme based on the inverse characteristics of the prestored characteristic of the transmission line leading to the subscriber-side termination apparatus, and
wherein the subscriber-side termination apparatus comprises:
a subscriber-side CP inserting unit that inserts a cyclic prefix into an uplink signal to be transmitted to the station-side termination apparatus and transmits the cyclic prefix-inserted signal to the station-side termination apparatus; and
a subscriber-side CP removing unit that generates a downlink CP-removed signal by removing a cyclic prefix from a downlink signal received from the station-side termination apparatus.

3. The optical access system according to claim 1, wherein the station-side equalization unit comprises:
an FFT unit that transmits the uplink CP-removed signal into a frequency domain signal;
an equalization unit that performs equalization on the received signal after the transformation to frequency domain, based on the inverse characteristic of the prestored characteristic of the transmission line leading to the subscriber-side termination apparatus; and
an inverse FFT unit that transmits the equalized received signal into a time domain signal, and
wherein the subscriber-side equalization unit comprises:
a subscriber-side FFT unit that transforms the downlink CP-removed signal into a frequency domain signal;
a subscriber-side equalization unit that performs equalization on the received signal after the transformation to frequency domain, based on the inverse characteristic of the prestored characteristic of the transmission line leading to the station-side termination apparatus; and
a subscriber-side inverse FFT unit that transforms the equalized received signal into a time domain signal.

4. The optical access system according to claim 2, wherein the station-side equalization unit comprises:
an FFT unit that transforms the uplink CP-removed signal into a frequency domain signal;
an equalization unit that performs equalization on the received signal after the transformation to frequency domain, based on the inverse characteristic of the prestored characteristic of the transmission line leading to the subscriber-side termination apparatus; and
an inverse FFT unit that transforms the equalized received signal into a time domain signal, and
wherein the station-side pre-equalization unit comprises:
a pre-equalization FFT unit that transforms the downlink signal to be transmitted to the subscriber-side termination apparatus into a frequency domain signal;
a pre-equalization unit that performs equalization on the downlink signal after the transformation to frequency domain, based on the inverse characteristic of the prestored characteristic of the transmission line leading to the subscriber-side termination apparatus; and
a pre-equalization inverse FFT unit that transforms the downlink equalized signal into a time domain signal and outputs the transformed signal as the pre-equalized signal.

5. A station-side termination apparatus in an optical access system including the station-side termination apparatus and a subscriber-side termination apparatus, the station-side termination apparatus comprising:
a CP inserting unit that inserts a cyclic prefix into a downlink signal to be transmitted to the subscriber-side termination apparatus and transmits the cyclic prefix-inserted signal to the subscriber-side termination apparatus;
a CP removing unit that generates a CP-removed uplink signal by removing a cyclic prefix from an uplink signal received from the subscriber-side termination apparatus; and
an equalization unit that performs equalization on the uplink CP-removed signal according to a frequency domain equalization scheme based on an inverse characteristic of the prestored characteristic of a transmission line leading to the subscriber-side termination apparatus.

6. A station-side termination apparatus in an optical access system including the station-side termination apparatus and a subscriber-side termination apparatus, the station-side termination apparatus comprising:
a pre-equalization unit that performs pre-equalization on a downlink signal to be transmitted to the subscriber-side termination apparatus according to a frequency domain equalization scheme based on an inverse characteristic of the prestored characteristic of a transmission line leading to the subscriber-side termination apparatus;
a CP inserting unit that generates a downlink CP-inserted signal by inserting a cyclic prefix into the pre-equalized signal and transmits the downlink CP-inserted signal to the subscriber-side termination apparatus;
a CP removing unit that generates an uplink CP-removed signal by removing a cyclic prefix from an uplink signal received from the subscriber-side termination apparatus; and
an equalization unit that performs equalization on the uplink CP-removed signal according to the frequency domain equalization scheme based on the inverse characteristic of the prestored characteristic of the transmission line leading to the subscriber-side termination apparatus.

7. A subscriber-side termination apparatus in an optical access system including a station-side termination apparatus and the subscriber-side termination apparatus, the subscriber-side termination apparatus comprising:
a CP inserting unit that inserts a cyclic prefix into an uplink signal to be transmitted to the station-side termination apparatus and transmits the cyclic prefix-inserted signal to the station-side termination apparatus;
a CP removing unit that generates a downlink CP-removed signal by removing a cyclic prefix from a downlink signal received from the station-side termination apparatus; and
an equalization unit that performs equalization on the downlink CP-removed signal according to a frequency domain equalization scheme based on an inverse characteristic of the prestored characteristic of a transmission line leading to the station-side termination apparatus.

8. A subscriber-side termination apparatus in an optical access system including a station-side termination apparatus and the subscriber-side termination apparatus, the subscriber-side termination apparatus comprising:
a CP inserting unit that inserts a cyclic prefix into an up signal to be transmitted to the station-side termination apparatus and transmits the cyclic prefix-inserted signal to the station-side termination apparatus; and
a CP removing unit that generates a downlink CP-removed down signal by removing a cyclic prefix from a downlink signal received from the station-side termination apparatus.
